(19) United States
(12) Patent Application Publication
(10) Pub. No.: US 2025/0219274 A1
(43) Pub. Date: Jul. 3, 2025

(54) Electrolyte Injection System and Electrolyte Injecting Method Using the Same

(71) Applicant: SK On Co., Ltd., Seoul (KR)

(72) Inventors: Jae Min RYU, Daejeon (KR); Joo Hun KIM, Daejeon (KR); Ha Young YU, Daejeon (KR); Jae Yong JO, Daejeon (KR)

(21) Appl. No.: 19/002,903

(22) Filed: Dec. 27, 2024

(30) Foreign Application Priority Data
Dec. 28, 2023 (KR) 10-2023-0194840

(51) Int. Cl. H01M 50/609; H01M 50/673

(52) U.S. Cl. CPC H01M 50/609; H01M 50/673

(57) ABSTRACT

An electrolyte injection system of the present disclosure includes: an injector configured to inject an electrolyte into an exterior case; an extractor configured to extract a portion of the electrolyte injected into the exterior case; a measurer configured to measure a weight of the exterior case into which the electrolyte is injected; and a controller configured to control the injector and the extractor to adjust an amount of the electrolyte located inside the exterior case based on the weight of the exterior case into which the electrolyte is injected.

### CROSS-REFERENCE TO RELATED PATENT APPLICATION

The present application claims priority under 35 U.S.C. § 119(a) to Korean patent application number 10-2023-0194840 filed on Dec. 28, 2023, in the Korean Intellectual Property Office, the entire disclosure of which is incorporated by reference herein.

### BACKGROUND OF THE INVENTION

### 1. Field

The present disclosure relates to an electrolyte injection system and an electrolyte injection method using the same. Specifically, the present disclosure relates to an electrolyte injection system and an electrolyte injection method capable of simply and easily injecting an electrolyte.

### 2. Description of the Related Art

A secondary battery is a battery which converts electrical energy into chemical energy, stores the chemical energy, and is reusable multiple times through charging and discharging. Secondary batteries are widely used in various industries due to their economical and eco-friendly characteristics. In particular, lithium secondary batteries are widely used in various industries, including portable devices which require high-density energy.

The secondary battery may include an electrolytic material along with an anode and a cathode which can produce electrical energy and store it or supply it to the outside. The electrolytic material may be provided in a solid form to form an all-solid-state battery, or in a liquid form to be injected into an exterior case.

To achieve optimal performance and stability, a predetermined amount of electrolyte should be injected into the exterior case. Therefore, research is actively being conducted on a technology to easily and simply inject the electrolyte in a preset amount.

### SUMMARY OF THE INVENTION

An object to be achieved by the present disclosure seeks is to easily and conveniently inject an electrolyte into an exterior case.

In addition, another object to be achieved by the present disclosure is to accurately inject an electrolyte according to a predetermined capacity.

The present disclosure may be widely applied in the field of green technology such as electric vehicles, battery charging stations, energy storage systems (ESS), and photovoltaics and wind power using batteries.

In addition, the present disclosure may be used for eco-friendly mobility, including electric and hybrid vehicles, to prevent climate change by suppressing air pollution and greenhouse gas emissions.

An electrolyte injection system of the present disclosure includes: an injector configured to inject an electrolyte into an exterior case; an extractor configured to extract a portion of the electrolyte injected into the exterior case; a measurer configured to measure a weight of the exterior case into which the electrolyte is injected; and a controller configured to control the injector and the extractor to adjust an amount of the electrolyte located inside the exterior case based on the weight of the exterior case into which the electrolyte is injected.

The controller may be configured to obtain an amount of the electrolyte injected into the exterior case based on the weight of the exterior case into which the electrolyte is injected and a weight of the exterior case before the electrolyte is injected.

The controller may be configured to obtain a value of a difference between the weight of the exterior case into which the electrolyte is injected and the weight of the exterior case before the electrolyte is injected and compare the obtained value with a reference value, and control the extractor to extract the electrolyte when the obtained value exceeds the reference value.

The controller may be configured to obtain a value of a difference between the weight of the exterior case into which the electrolyte is injected and the weight of the exterior case before the electrolyte is injected and compare the obtained value with a reference value, and control the injector to additionally inject the electrolyte when the obtained value is less than the reference value.

The exterior case may include an opening with one side open, and the extractor may be partially inserted through the opening to extract the electrolyte.

The extractor may include a nozzle part inserted into the exterior case through which the electrolyte moves; and a motor part configured to extract the electrolyte through the nozzle part.

The extractor may further include a guide part configured to press both sides of an opening of the exterior case.

The guide part may be configured to press both sides of the opening and close the opening.

The extractor may further include a blowing part configured to supply gas toward the nozzle part.

The extractor may further include a storage in which one end of the nozzle part is immersed and stored.

An electrolyte injection method of the present disclosure includes: injecting an electrolyte into an exterior case; measuring an injection amount of the electrolyte based on a weight of the exterior case into which the electrolyte is injected and a weight of the exterior case before the electrolyte is injected; and adjusting an amount of the electrolyte located inside the exterior case based on the injection amount of the electrolyte.

The measuring of the injection amount of the electrolyte may include measuring the weight of the exterior case into which the electrolyte is injected; and obtaining a value of a difference between the weight of the exterior case into which the electrolyte is injected and the weight of the exterior case before the electrolyte is injected.

The adjusting of the amount of the electrolyte located inside the exterior case may include additionally injecting the electrolyte when the obtained value is less than a preset reference value.

The adjusting of the amount of the electrolyte located inside the exterior case may include extracting the electrolyte when the obtained value exceeds the preset reference value.

The electrolyte injection method may further include obtaining a difference between a weight of the exterior case with the adjusted amount of the electrolyte and the weight of the exterior case before the electrolyte is injected and re-comparing the difference with the preset reference value.

The extracting of the electrolyte may include inserting at least a portion of a nozzle part into an opening formed on one side of the exterior case; and moving the electrolyte by the motor part.

The adjusting of the amount of the electrolyte located inside the exterior case may include pressing the opening by a guide part formed to extend along both sides of the opening.

The adjusting of the amount of the electrolyte located inside the exterior case may further include supplying gas toward the nozzle part by a blowing part.

The adjusting of the amount of the electrolyte located inside the exterior case may further include moving one end of the nozzle part so as to be immersed into a storage provided outside the exterior case.

According to one embodiment of the present disclosure, it is possible to easily inject an electrolyte into an exterior case.

In addition, it is possible to accurately inject the electrolyte according to a set capacity.

In addition, it is possible to manufacture an electrode assembly with improved stability and performance.

### BRIEF DESCRIPTION OF THE DRAWINGS

FIG. 1 is a diagram illustrating a configuration of an electrolyte injection system according to an embodiment of the present disclosure.

FIGS. 2 and 3 illustrate a battery cell according to an embodiment of the present disclosure.

FIGS. 4 to 7 are diagrams illustrating a process of injecting an electrolyte into an electrolyte injection system according to an embodiment of the present disclosure.

FIGS. 8 to 10 are flow charts illustrating an electrolyte injection method according to an embodiment of the present disclosure.

### DETAILED DESCRIPTION

Hereinafter, the present disclosure will be described in detail with reference to the accompanying drawings. However, this is merely exemplary and the present disclosure is not limited to specific embodiments described by way of example.

Specific terms used in the present specification are merely for convenience of explanation and are not intended to limit the illustrated embodiments.

For example, expressions such as “identical” and “the same” not only indicate a strictly identical state, but also indicate a state in which there is a tolerance or a difference of the degree to which the same function is obtained.

For example, expressions indicating relative or absolute arrangements such as “in a direction”, “along a direction”, “parallel”, “perpendicular”, “centered”, “concentric”, or “coaxial” not only indicate the exact arrangements, but also indicate a state of relative displacement with tolerance or an angle or distance which provides the same function.

To describe the present disclosure, the following is explained based on a spatial orthogonal coordinate system with an X-axis, a Y-axis, and a Z-axis being orthogonal to each other. A direction of each axis (an X-axis direction, a Y-axis direction, or a Z-axis direction) refers to both directions in which the axis extends.

The X, Y, and Z directions mentioned below are provided for the purpose of explanation so that the present disclosure can be clearly understood, and it is to be understood that each direction may be defined differently depending on where the reference is placed.

The use of terms such as ‘first’, ‘second’, and ‘third’ before components mentioned below is only intended to avoid confusion regarding the components they refer to, and has nothing to do with the order, importance, or main-subordinate relationship between the components. For example, an invention which includes only a second component without a first component may be implemented.

As used herein, singular expressions include plural expressions unless the context clearly indicates otherwise.

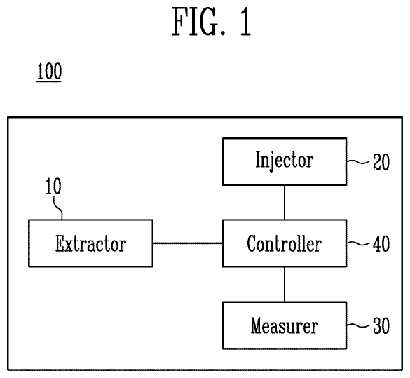

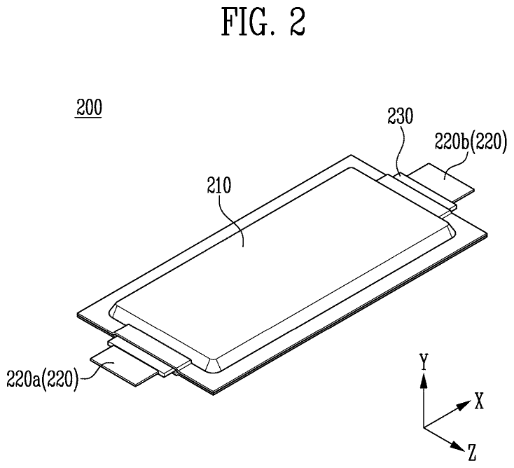

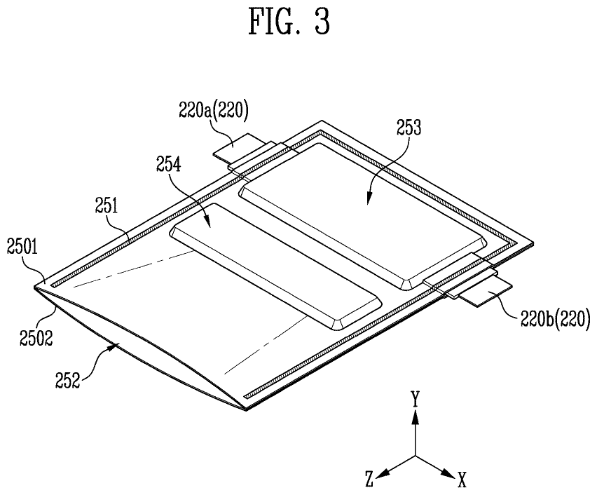

FIG. 1 is a diagram illustrating a configuration of an electrolyte injection system 100 according to an embodiment of the present disclosure, and FIGS. 2 and 3 illustrate a battery cell 200 according to an embodiment of the present disclosure.

Referring to FIG. 1, the electrolyte injection system 100 of the present disclosure includes an injector 20 injecting an electrolyte (EL) into an exterior case 250, an extractor 10 extracting a portion of the electrolyte (EL) injected into the exterior case 250, a measurer 30 measuring a weight of the exterior case 250 into which the electrolyte (EL) is injected, and a controller 40 controlling the injector and the extractor to adjust the amount of the electrolyte (EL) located inside the exterior case 250 based on the weight of the exterior case 250 into which the electrolyte (EL) is injected.

In an embodiment, the electrolyte (EL) located inside the exterior case 250 may be the electrolyte remaining inside the exterior case 250 after the electrolyte has been injected.

The controller may control each of the injector, the extractor, and the measurer. The controller may control the injector, the extractor, and the measurer at the same time, or separately.

In other words, the controller may control the injector, the extractor, and the measurer, such that the injector injects the electrolyte or the extractor extracts the electrolyte.

The electrolyte injection system 100 of the present disclosure may inject the electrolyte (EL) into the exterior case 250. The exterior case 250 may be the exterior case 250 of the battery cell 200. Referring to FIG. 2, the battery cell 200 according to the present disclosure may include the main body 210 which produces or stores electrical energy, and a tab part 220 protruding outside of the main body 210.

The main body 210 may include an electrode assembly (not shown) including a cathode, an anode, and a separator therein for the production and storage of electrical energy.

On the other hand, the main body 210 may further include an electrolytic material in contact with the electrode assembly. The electrolytic material may be an electrolyte (EL) provided as a liquid.

The main body 210 may further include the exterior case 250. The exterior case 250 may include the electrode assembly and the electrolyte (EL) inside.

FIG. 2 illustrates an example of the pouch-shaped battery cell 200, but is not limited thereto. Therefore, the present disclosure may also be applied to prismatic and cylindrical battery cells 200.

In addition, the exterior case 250 may include a sealing part 251. The sealing part 251 may be formed along an edge of the exterior case 250. The exterior case 250 may be sealed along the sealing part 251. In an embodiment, the exterior case 250 may include an upper cover 2501 and a lower cover 2502, and the upper cover 2501 and the lower cover 2502 may be sealed along the sealing part 251 to form an accommodation space in which the electrode assembly is accommodated.

Specifically, FIG. 3 illustrates an example of the exterior case 250 in a manufacturing process of the battery cell 200. Referring to FIG. 3, all edges except one edge of the exterior case 250 may be sealed. The one edge which is not sealed may be bent. A portion of the one unsealed edge of the exterior case 250 may be opened to form an opening 252. The electrolyte (EL) may be injected or the electrolyte (EL) may be extracted through the opening 252.

In addition, the accommodation space may include a main room 253 in which the main body 210 may be installed and a gas room 254 in which gas is collected for discharge. The main room 253 and the gas room 254 may communicate with each other. Therefore, gas generated in the main room 253 may be moved to the gas room 254.

When the opening 252 is positioned so that it faces upward, the main room 253 may be positioned at the lower end of the exterior case 250, and the gas room 254 may be positioned above the main room 253. The gas room 254 may communicate with the outside through the opening 252. Through this structure, the gas generated in the main room 253 may be easily discharged.

The tab part 220 may include a first tab part 220a and a second tab part 220b protruding in a direction away from the main body 210 on both sides of the main body 210. This is one example, and the tab part 220 may have both tabs on one side. The first tab part 220a and the second tab part 220b may be positive and negative tabs, respectively. The tab part 220 may be interposed between the exterior case 250 and protrude to the outside.

The battery cell 200 may further include an insulation cover 230 insulating between the tab part 220 and the exterior case 250. The insulation cover 230 may be located between the tab part 220 and the exterior case 250 while surrounding the tab part 220 to prevent contact between the tab part 220 and the exterior case 250.

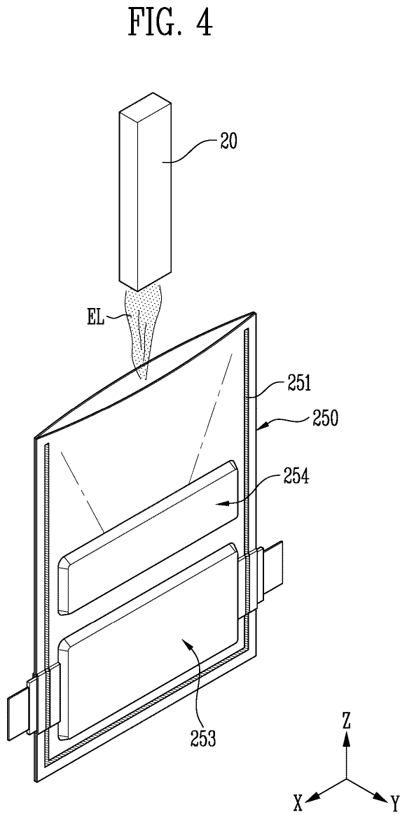

FIGS. 4 to 7 are diagrams illustrating a process of injecting the electrolyte (EL) into the electrolyte injection system 100 according to an embodiment of the present disclosure.

Referring to FIG. 4, the injector 20 may inject the electrolyte (EL) into the exterior case 250. As described above, the exterior case 250 may include the opening 252 formed by sealing three sides and opening one side. The injector 20 may be provided in the form of a syringe or nozzle to inject the electrolyte (EL) inside. Of course, without being limited thereto, the injector may use any configuration for injecting the electrolyte (EL). For example, the injector 20 may be a servo pump.

The electrolyte (EL) needs to be injected into the exterior case in a preset capacity. The preset capacity may be called a reference value. The reference value may refer to a capacity set or designed by a user to achieve appropriate performance. The reference value may include a tolerance. In other words, the reference value may refer to a value which falls within a predetermined range with a tolerance based on a particular value.

If the electrolyte (EL) is injected excessively or insufficiently, the performance of the battery cell (200) may deteriorate. Therefore, setting an injection amount of the electrolyte (EL) and actually injecting the set injection amount of the electrolyte (EL) is important to maximize the performance of the battery cell 200.

To this end, the electrolyte injection system 100 of the present disclosure injects the electrolyte (EL) into the exterior case 250, measures the weight of the exterior case 250 into which the electrolyte (EL) is injected, and then adjusts the amount of the electrolyte (EL) located inside the exterior case 250 based on the measured weight, thereby allowing an appropriate amount of the electrolyte (EL) to be included inside the exterior case.

The injector 20 may be set to inject the electrolyte (EL) equivalent to the reference value into the exterior case 250. However, during the electrolyte (EL) injection process, the electrolyte (EL) may be injected excessively or insufficiently compared to the reference value due to malfunction of the injector 20, equipment failure, or excessive splashing.

Whether there is over- or under-injection may be determined by measuring the weight of the exterior case 250. The measurer 30 may measure the weight of the exterior case 250 containing the electrolyte (EL). The measurer 30 may be a scale. Without being limited thereto, the measurer 30 may apply a configuration capable of measuring the weight. In an embodiment, the measurer 30 may be integrated with the controller 40.

The controller 40 may control the inlet and the extraction unit to adjust the amount of electrolyte (EL) injected into the exterior case 250 based on the weight of the exterior case 250 into which the electrolyte (EL) is injected.

The controller 40 may obtain the amount of electrolyte (EL) injected into the exterior case 250 based on the weight of the exterior case 250 into which the electrolyte (EL) is injected and the weight of the exterior case 250 before the electrolyte (EL) is injected.

Before the electrolyte (EL) is injected, the weight of the exterior case 250 may be input into the controller 40 by the user in advance. Alternatively, the measurer may weigh the exterior case 250 before the electrolyte (EL) is injected.

The controller 40 may compare the weight of the exterior case 250 into which the electrolyte (EL) is injected with a preset value to determine whether the electrolyte (EL) is injected properly. Here, the preset value may be the weight of the exterior case 250 before the electrolyte (EL) is injected plus the reference value. In other words, if the weight of the exterior case 250 into which the electrolyte (EL) is injected is the same as the sum of the weight of the exterior case 250 and the reference value, the controller 40 may determine that the appropriate amount of the electrolyte (EL) has been injected. Here, whether they are the same may be determined by considering the tolerance.

Further, the controller 40 may obtain a value of a difference between the weight of the exterior case 250 after the electrolyte (EL) is injected and the weight of the exterior case 250 before the electrolyte (EL) is injected and compare the obtained value with the reference value. Here, the weight of the exterior case 250 before the electrolyte (EL) is injected may be input in advance by the user. Alternatively, the measurer 30 may measure the weight of the exterior case 250 before the electrolyte (EL) is injected.

In other words, the controller 40 may measure the amount of electrolyte (EL) injected into the exterior case by comparing the weight of the exterior case 250 into which the electrolyte is injected and the weight of the exterior case 250 which is not injected with the electrolyte. Then, the controller 40 may compare the amount of electrolyte (EL) injected into the exterior case with the reference value.

If the electrolyte (EL) is splashed outside the exterior case 250 or is injected in less quantity than the preset capacity due to equipment failure, the obtained value will be lower than the reference value. As another example, if the electrolyte (EL) is over-injected, the obtained value will exceed the reference value.

The controller 40 may control the injector so that the injector 20 injects additional electrolyte (EL) when the obtained value is below the reference value. Here, the amount of electrolyte (EL) additionally injected may be the difference between the reference value and the obtained value. The controller 40 may control the injector to inject the electrolyte (EL) equal to the difference between the reference value and the obtained value.

The controller 40 may control the extractor 10 to extract the electrolyte (EL) when the obtained value exceeds the reference value. Here, the amount of electrolyte (EL) extracted may be the difference between the reference value and the obtained value.

In another example, the amount of electrolyte (EL) extracted may be greater than the difference between the reference value and the obtained value. If an amount of electrolyte (EL) greater than the difference between the reference value and the obtained value is extracted from the exterior case 250, the electrolyte (EL) inside the exterior case 250 will be insufficient compared to the reference value. Afterwards, the weight may be measured again and the electrolyte (EL) may be injected.

In other words, the controller 40 may measure the weight of the exterior case 250 containing the electrolyte (EL) and compare it with the weight of the exterior case 250 in which the electrolyte (EL) is not injected to acquire the obtained value, and then compare the obtained value with the reference value.

Thereafter, if the reference value and the obtained value are different, the difference between the reference value and the obtained value is calculated, and the injector and the extractor may be controlled to adjust the amount of electrolyte (EL) injected into the exterior case (250) by injecting or extracting an amount of electrolyte (EL) corresponding to the difference between the reference value and the obtained value.

In another example, the amount of electrolyte (EL) to be injected or extracted may be preset by the user. For example, it may be 2% of the amount of electrolyte (EL) located inside the exterior case 250. Through this, since the process of calculating the difference between the weight of the exterior case 250 and the reference value may be omitted, injection of the electrolyte (EL) may proceed quickly.

On the other hand, when additionally injecting the electrolyte (EL) to adjust the amount of electrolyte (EL), a micro-injector (not shown) for micro-injection may be used. The micro-injector may be a separate configuration from the injector 20. Without being limited thereto, the injector may have the function of injecting a trace amount of electrolyte.

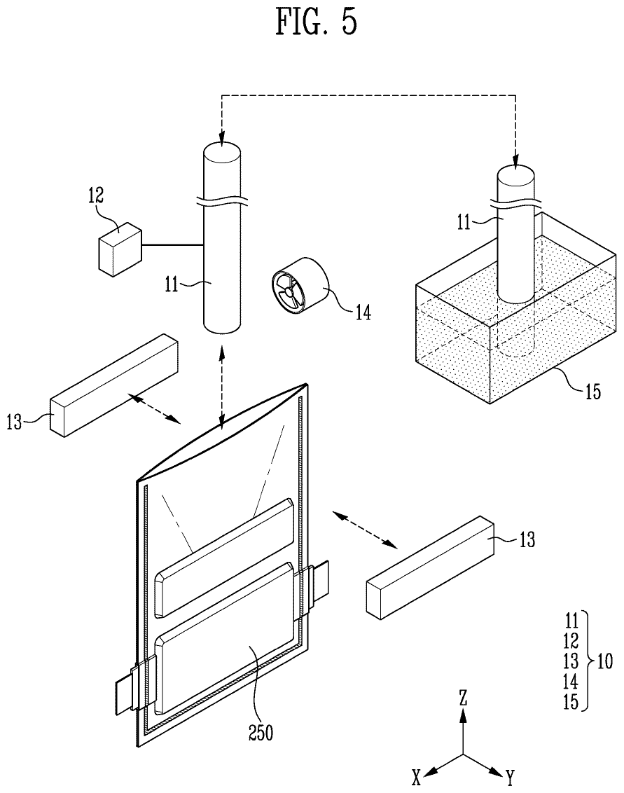

Specifically, FIG. 5 is a diagram schematically illustrating the extractor 10. The extractor 10 is partially inserted through the opening 252 of the exterior case 250 so that the electrolyte (EL) may be extracted. The extractor 10 may include a nozzle part 11 inserted into the exterior case 250 through which the electrolyte (EL) moves, and a motor part 12 which extracts the electrolyte (EL) through the nozzle part 11.

For example, the nozzle part 11 may be provided in the form of a nozzle. There is no limitation on the shape of the nozzle part as long as it can extract the electrolyte through one end.

In order for the extractor 10 to extract the electrolyte (EL), the motor part 12 may vacuum the inside of the nozzle part 11. Referring to FIG. 5, the motor part 12 may be configured separately from the nozzle part 11.

In another embodiment, the motor part 12 may be formed integrally with the nozzle part 11. In other words, the nozzle part 11 may be formed at one end of a body, and the motor part 12 may be located inside the body. Without being limited thereto, the extractor 10 may use a known configuration capable of extracting the electrolyte (EL).

Therefore, the amount of electrolyte (EL) located inside the exterior case 250 may be reduced by extracting the electrolyte (EL) through the nozzle part 11. One end of the extractor 10 is immersed in the electrolyte (EL) so that the electrolyte (EL) may be extracted. This allows for efficient extraction. For example, the extractor 10 may be a vacuum ejector.

Preferably, one end of the extractor 10 may not come into contact with the electrode assembly. This is to prevent damage to the electrode assembly. Therefore, one end of the extractor 10 may be located inside the exterior case 250 at a predetermined distance from the electrode assembly.

The extractor 10 may further include a guide part 13 which presses both sides of the opening 252 of the exterior case 250. The guide part 13 may press both sides of the opening 252, so that an inner face of the opening 252 and the nozzle part 11 may come into strong contact.

The guide part 13 may be provided on each side of the opening 252 so as to extend in a direction parallel to the direction in which the opening 252 of the battery cell 200 extends. The opening 252 may be extended for efficient injection of the electrolyte. Referring to FIGS. 4 and 5, the opening may extend along the X-axis direction. Here, both sides of the opening 252 may face each other with the opening as the center. The both sides of the opening 252 may refer to faces facing the Y-axis direction of the opening.

In other words, a pair of the guide parts 13 are provided, and the guide parts 13 may move in the direction of getting closer or farther away from each other. The guide parts 13 may come closer to each other and press the battery cell.

The opening 252 may be closed by the guide parts 13. During the extraction process, the electrolyte (EL) inside the exterior case 250 may be scattered and discharged to the outside. In order to prevent the discharge of the electrolyte (EL), the guide parts 13 may close the opening 252 while the nozzle part 11 is inserted into the exterior case 250.

In another embodiment, after the guide part 13 comes into contact with the exterior case 250, the pressurized pressure may increase to suppress movement of air inside and outside the opening 252. Preferably, the movement of air inside and outside the exterior case 250 through the opening 252 may be blocked by the guide part 13. The guide part 13 may be controlled by the controller 40.

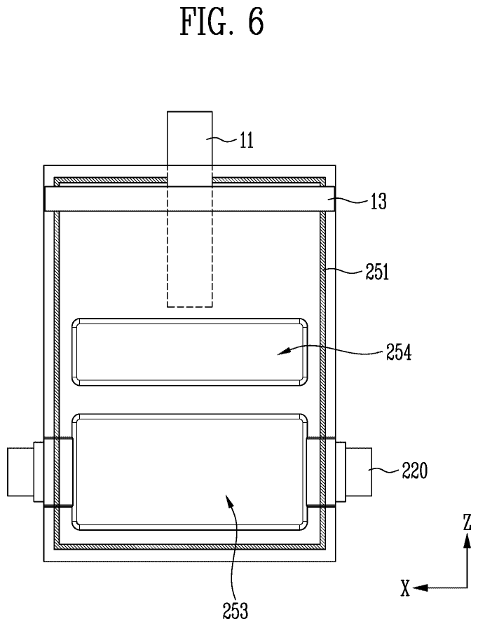

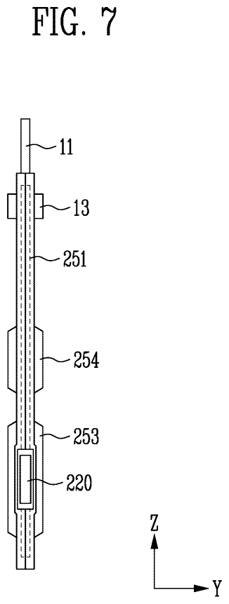

Specifically, FIG. 6 and FIG. 7 illustrate the guide part 13 pressing the opening 252. Referring to FIGS. 6 and 7, the guide part 13 may press the opening 252 formed in an upper part of the exterior case 250. This allows the guide part 13 to close the opening 252.

The position of the guide part 13 may overlap with the nozzle part 11 when the nozzle part 11 is inserted into the opening 252. In other words, the guide part 13 may press the nozzle part 11 and the exterior case 250 simultaneously.

The length of the guide part 13 along the direction in which the opening 252 extends may be greater than or equal to the length of the opening 252. This is to minimize the amount of electrolyte which is scattered by covering the entire opened area of the opening 252 by the guide part 13.

The extractor 10 may further include a blowing part 14 which supplies gas toward the nozzle part 11. The blowing part 14 may supply a strong wind towards the nozzle part 11. The electrolyte (EL) located on the outside of the nozzle part 11 may be removed by the wind supplied by the blowing part 14.

Alternately, as will be described later, the nozzle part 11 may be immersed and stored in a storage 15. Here, a storage solution stuck on the outside of the nozzle part 11 may be removed by the blowing part 14.

For example, referring to FIG. 5, the blowing part 14 may spray the air strongly toward an end of the nozzle part 11. Through this, the nozzle part 11 may be dried by evaporating the liquid located at the end of the nozzle part 11 or by separating it from the nozzle part 11 by the strong wind.

On the other hand, the extractor 10 may further include the storage 15 in which one end of the nozzle part 11 is immersed and stored. The storage 15 may contain the storage solution inside. The storage solution may be ethanol or isopropyl alcohol. When the nozzle part 11 is not used in the extraction process, it may be positioned while being immersed in the storage solution of the storage 15.

After the nozzle part 11 is used for extraction, the electrolyte (EL) may be located at the end of the nozzle part 11. The electrolyte (EL) may solidify over time and cause damage to the nozzle part 11. When the end of the nozzle part 11 is immersed in the storage solution, it is possible to prevent clogging of the nozzle part 11 due to solidification of the electrolyte (EL).

Hereinafter, an electrolyte (EL) injection method of the present disclosure will be described in detail with reference to the drawings.

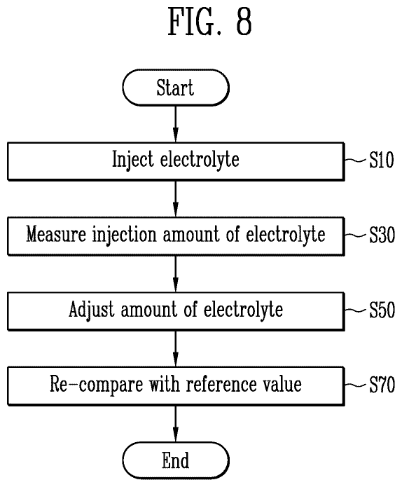

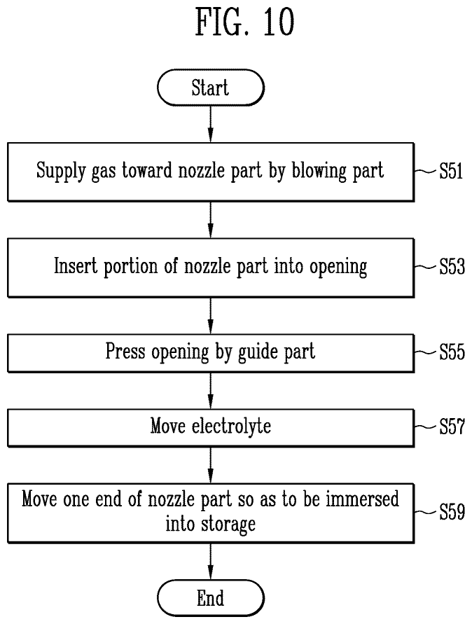

FIGS. 8 to 10 are flow charts illustrating the electrolyte (EL) injection method according to an embodiment of the present disclosure.

Referring to FIG. 8, the electrolyte (EL) injection method of the present disclosure includes injecting the electrolyte (EL) into the exterior case 250 (S10), measuring an injection amount of the electrolyte (EL) based on a weight of the exterior case 250 into which the electrolyte (EL) is injected and the weight of the exterior case 250 before the electrolyte (EL) is injected (S30), and adjusting an amount of the electrolyte (EL) located inside the exterior case 250 based on the weight of the exterior case containing the electrolyte (S50).

A manufacturing method of the present disclosure may perform the step of measuring the injection amount of the electrolyte (EL) (S30) after the step of injecting the electrolyte (EL) into the exterior case 250 (S10).

The manufacturing method of the present disclosure may further include a step (not shown) of measuring the weight of the exterior case 250 prior to the step of injecting the electrolyte (EL) into the exterior case 250 (S10).

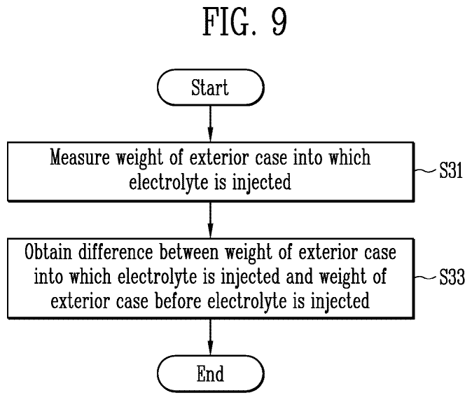

In addition, referring to FIG. 9, the measuring of the injection amount of the electrolyte (EL) (S30) may further include measuring the weight of the exterior case into which the electrolyte (EL) is injected (S31) and obtaining a value of a difference between the weight of the exterior case into which the electrolyte (EL) is injected and the weight of the exterior case before the electrolyte (EL) is injected (S33).

The manufacturing method of the present disclosure may perform, after the step of measuring the injection amount of the electrolyte (EL) (S30), the step of adjusting the amount of the electrolyte located inside the exterior case based on the injection amount of the electrolyte (S50).

The step of adjusting the amount of the electrolyte (EL) located inside the exterior case 250 (S50) may further include a step (not shown) of injecting additional electrolyte (EL) if the obtained value is below a preset reference value.

Further, the step of adjusting the amount of the electrolyte (EL) located inside the exterior case 250 (S50) may further include a step (not shown) of extracting the electrolyte (EL) when the obtained value exceeds the preset reference value.

Refer to FIG. 8 again, after the step of adjusting the amount of the electrolyte (S50), the electrolyte (EL) injection method of the present disclosure may include obtaining a difference between the weight of the exterior case 250 with the adjusted amount of the electrolyte (EL) and the weight of the exterior case 250 before the electrolyte (EL) is injected and re-comparing it with the preset reference value.

The step of re-comparing (S70) may further include a step (not shown) of measuring the weight of the exterior case 250 with the adjusted amount of the electrolyte (EL).

The amount of the electrolyte (EL) may be readjusted by re-comparing the difference between the weight of the exterior case 250 with the adjusted amount of the electrolyte (EL) and the weight of the exterior case 250 before the electrolyte (EL) is injected with the preset reference value. In other words, when the difference between the weight of the exterior case 250 with the adjusted amount of the electrolyte (EL) and the weight of the exterior case 250 before the electrolyte (EL) is injected exceeds or is less than the preset reference value, the electrolyte (EL) may be injected or extracted again.

The step of adjusting the amount of the electrolyte (S50) may further include inserting at least a portion of the nozzle part 11 into the opening 252 opened on one side of the exterior case 250 (S53) and moving the electrolyte (EL) by the motor part 12 (S57).

The electrolyte injection method of the present disclosure may perform, after the step of inserting the nozzle part 11 into the opening (S53), the step of moving the electrolyte by the motor part 12 (S57). The electrolyte may be extracted from the inside of the exterior case to the outside of the exterior case by the motor unit 12.

Specifically, after one end of the nozzle part 11 is located in the opening 252, the nozzle part 11 may be moved downward to be injected into the exterior case 250. Since the exterior case 250 contains the electrolyte (EL) inside and the opening 252 is located at the upper part of the exterior case 250, the nozzle part 11 will move downward and be inserted inside the exterior case 250.

The injection method of the present disclosure may perform, after the nozzle part 11 is inserted into the opening 252, pressing the opening 252 by the guide part 13 (S55) before the electrolyte (EL) is moved by the motor part 12. The reason for pressing by the guide part 13 is to prevent the electrolyte (EL) from scattering and being discharged to the outside of the exterior case 250 or to form a vacuum by blocking the inside and outside of the exterior case 250. Extraction may be easily performed in the vacuum.

The electrolyte injection method of the present disclosure may perform moving one end of the nozzle part 11 so that it is immersed in the storage 15 provided outside the exterior case 250 after the electrolyte (EL) is extracted (S59). The nozzle part 11 may be immersed in the storage solution, so that the electrolyte (EL) can be prevented from solidifying and clogging the nozzle part 11.

In an embodiment, the nozzle part 11 may be used repeatedly. In this case, the nozzle part 11 immersed in the storage 15 may be moved towards an upper part of the opening 252. The electrolyte injection method of the present disclosure may proceed with a step of supplying gas toward the nozzle part 11 by the blowing part 14 (S51) prior to the step of inserting the nozzle part 11 into the opening 252 (S53). For example, the blowing part 14 may spray the gas toward the nozzle part 11. The blowing part 14 may dry the nozzle part 11, or remove the storage solution located on the outside of the nozzle part 11.

The present disclosure may be embodied in various forms, and the scope of the present disclosure is not limited to the above embodiments. Therefore, if a modified embodiment includes a component of the present disclosure, it should be construed to fall within the scope of the rights of the present disclosure.

What is claimed is:

1. An electrolyte injection system comprising:
an injector configured to inject an electrolyte into an exterior case;
an extractor configured to extract a portion of the electrolyte injected into the exterior case;
a measurer configured to measure a weight of the exterior case into which the electrolyte is injected; and
a controller configured to control the injector and the extractor to adjust an amount of the electrolyte located inside the exterior case based on the weight of the exterior case into which the electrolyte is injected.

2. The electrolyte injection system according to claim 1, wherein the controller is configured to obtain an amount of the electrolyte injected into the exterior case based on the weight of the exterior case into which the electrolyte is injected and a weight of the exterior case before the electrolyte is injected.

3. The electrolyte injection system according to claim 2, wherein the controller is configured to obtain a value of a difference between the weight of the exterior case into which the electrolyte is injected and the weight of the exterior case before the electrolyte is injected and compare the obtained value with a reference value, and
control the extractor to extract the electrolyte when the obtained value exceeds the reference value.

4. The electrolyte injection system according to claim 2, wherein the controller is configured to obtain a value of a difference between the weight of the exterior case into which the electrolyte is injected and the weight of the exterior case before the electrolyte is injected and compare the obtained value with a reference value, and
control the injector to additionally inject the electrolyte when the obtained value is less than the reference value.

5. The electrolyte injection system according to claim 1, wherein the exterior case comprises an opening with one side open, and the extractor is partially inserted through the opening to extract the electrolyte.

6. The electrolyte injection system according to claim 1, wherein the extractor comprises:
a nozzle part inserted into the exterior case through which the electrolyte moves; and
a motor part configured to extract the electrolyte through the nozzle part.

7. The electrolyte injection system according to claim 6, wherein the extractor further comprises a guide part configured to press both sides of an opening of the exterior case.

8. The electrolyte injection system according to claim 7, wherein the guide part is configured to press both sides of the opening and close the opening.

9. The electrolyte injection system according to claim 6, wherein the extractor further comprises a blowing part configured to supply gas toward the nozzle part.

10. The electrolyte injection system according to claim 6, wherein the extractor further comprises a storage in which one end of the nozzle part is immersed and stored.

11. An electrolyte injection method comprising:
injecting an electrolyte into an exterior case;
measuring an injection amount of the electrolyte based on a weight of the exterior case into which the electrolyte is injected and a weight of the exterior case before the electrolyte is injected; and
adjusting an amount of the electrolyte located inside the exterior case based on the injection amount of the electrolyte.

12. The electrolyte injection method according to claim 11, wherein the measuring of the injection amount of the electrolyte comprises:
measuring the weight of the exterior case into which the electrolyte is injected; and
obtaining a value of a difference between the weight of the exterior case into which the electrolyte is injected and the weight of the exterior case before the electrolyte is injected.

13. The electrolyte injection method according to claim 12, wherein the adjusting of the amount of the electrolyte located inside the exterior case comprises additionally injecting the electrolyte when the obtained value is less than a preset reference value.

14. The electrolyte injection method according to claim 12, wherein the adjusting of the amount of the electrolyte located inside the exterior case comprises extracting the electrolyte when the obtained value exceeds the preset reference value.

15. The electrolyte injection method according to claim 11, further comprising obtaining a difference between a weight of the exterior case with the adjusted amount of the electrolyte and the weight of the exterior case before the electrolyte is injected and re-comparing the difference with preset reference value.

16. The electrolyte injection method according to claim 14, wherein the extracting of the electrolyte comprises:
inserting at least a portion of a nozzle part into an opening formed on one side of the exterior case; and
moving the electrolyte by the motor part.

17. The electrolyte injection method according to claim 16, wherein the adjusting of the amount of the electrolyte located inside the exterior case further comprises pressing the opening by a guide part formed to extend along both sides of the opening.

18. The electrolyte injection method according to claim 16, wherein the adjusting of the amount of the electrolyte located inside the exterior case further comprises supplying gas toward the nozzle part by a blowing part.

19. The electrolyte injection method according to claim 16, wherein the adjusting of the amount of the electrolyte located inside the exterior case further comprises moving one end of the nozzle part so as to be immersed into a storage provided outside the exterior case.
